(19) United States
(12) Patent Application Publication
(10) Pub. No.: US 2024/0394665 A1
(43) Pub. Date: Nov. 28, 2024

(54) System and Method for Event Scheduling Management

(71) Applicant: Keyboard Jockey, LLC, Plano, TX (US)

(72) Inventor: Jeffrey I. Mosoff, Plano, TX (US)

(21) Appl. No.: 18/324,582

(22) Filed: May 26, 2023

(51) Int. Cl. G06Q 10/1093

(52) U.S. Cl. CPC G06Q 10/1097

(57) ABSTRACT

A system and method for event scheduling management, the system including a processor, and a non-transitory computer readable medium storing a program for execution by the processor, and including instructions for providing a service state machine for a service selected for an organizer event, setting a state of each action state machine of a plurality of action state machines associated with a plurality of actions to an active state, setting the state causing the action state machine to perform elements associated with a respective action associated while the state of the respective action machine is active, where each action of the plurality of actions is identified by a provider prior to the service state machine being provided, and setting a state of the service state machine to a ready-to-deliver state after each action state machine of the plurality of action state machines completes performance of associated elements.

### TECHNICAL FIELD

The present invention relates generally to a system and method for controlling system schedules, and, in particular embodiments, to a system and method for using multiple state machines to verify completion of scheduled process actions.

### BACKGROUND

Generally, when providing services for events such as gatherings, celebratory events, sales presentation or meeting, conferences, or other types of events where multiple vendors or service providers are hired, each party interaction is independent, potentially resulting in missed actions or event approvals, or other missed features for the related event. This is because each vendor creates their own schedule and process for handling feature selections, enforcement of feature order, delivery schedules, and the like. With each different vendor using a different process, inadvertently missed features may result in incorrect service provision or delivery.

For example, in the wedding industry, a baker may have a different schedule for ordering a cake than the schedule provided by a venue, tailor, a florist, a caterer, or another vendor. Thus, a tailor, for example, may generally have a general and final fitting for a dress, while a cake baker may have a tasting, rather than a fitting. Additionally, a tailor may require more time to make or customize a dress than a baker will require to bake and decorate a cake. Similarly, a caterer may need to schedule waitstaff or bartenders, which may take longer than a baker requires to bake a cake. Thus, each type of vendor in the wedding industry may have different scheduling and action requirements. Furthermore, each individual vendor may provide different services, schedules, features, actions or other elements of a service that may need to be customized based on the type of service provided and the individual vendor's business.

Similarly, in the convention and trade show space, a venue or organizer may employ multiple vendors, and each vendor may have unique requirements, schedules, actions, service and features. For example, a convention organizer may need to book a venue long before the organizer needs to book security, parking management, custodial or cleanup services, locality permit acquisition, and the like.

### SUMMARY

An embodiment system includes a processor, and a non-transitory computer readable medium storing a computer program for execution by the processor for managing event scheduling. The computer program including instructions for providing a service state machine for a service selected by an organizer for an organizer event, setting, by the service state machine, a state of each action state machine of a plurality of action state machines associated with a plurality of actions associated with the service to an active state, the setting the state causing the action state machine to perform elements associated with a respective action associated with the respective action state machine while the state of the respective action machine is active, where the service state machine sets the state of each action state machine according to an order of the plurality of actions, where each action of the plurality of actions is identified by a provider prior to the service state machine being provided, where at least one action has an element that includes receiving an action performance indication from the organizer, and setting a state of the service state machine to a ready-to-deliver state after each action state machine of the plurality of action state machines completes performance of associated elements.

An embodiment system includes a processor and a non-transitory computer readable medium storing a computer program for execution by the processor for managing event scheduling. The computer program including instructions for providing a service state machine for a service selected for an organizer event, identifying a plurality of actions associated with the service, providing at least one action state machine associated with the plurality of actions, and controlling, by the service state machine, running of the at least one action state machine to perform the plurality of actions in sequence.

An embodiment method for managing event scheduling includes providing a service state machine for a service selected for an organizer event, identifying a plurality of actions associated with the service, providing at least one action state machine associated with the plurality of actions, and controlling, by the service state machine, running of the at least one action state machine to perform the plurality of actions in sequence.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a logical diagram illustrating an event scheduling management system according to some embodiments;

FIG. 2 is a logical diagram illustrating a data arrangement for providing a scheduling management system according to some embodiments;

FIG. 3 is a logical diagram illustrating a scheduling management system for an organizer event according to some embodiments;

FIG. 4 is a diagram illustrating handling of multiple action state machines by a service state machine according to some embodiments;

FIG. 5 is a diagram illustrating a logical structure for storing data related to an organizer event according to some embodiments;

FIG. 6 is a diagram illustrating a state arrangement for a service state machine according to some embodiments;

FIG. 7 is a diagram illustrating a state arrangement for an action state machine according to some embodiments;

FIG. 8 is a logical diagram illustrating a data relationship arrangement according to some embodiments;

FIG. 9 is a flow diagram illustrating a process for providing events and services, and executing the state engines for managing the services according to some embodiments;

FIG. 10 is a flow diagram illustrating a method of using a scheduling management system according to some embodiments; and

FIG. 11 is a flow diagram illustrating a method of running a scheduling management system according to some embodiments.

### DETAILED DESCRIPTION OF ILLUSTRATIVE EMBODIMENTS

Illustrative embodiments of the system and method of the present disclosure are described below. In the interest of clarity, all features of an actual implementation may not be described in this specification. It will of course be appreciated that in the development of any such actual embodiment, numerous implementation-specific decisions may be made to achieve the developer's specific goals, such as compliance with system-related and business-related constraints, which will vary from one implementation to another. Moreover, it should be appreciated that such a development effort might be complex and time-consuming but would nevertheless be a routine undertaking for those of ordinary skill in the art having the benefit of this disclosure.

Reference may be made herein to the spatial relationships between various components and to the spatial orientation of various aspects of components as the devices are depicted in the attached drawings. However, as will be recognized by those skilled in the art after a complete reading of the present disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

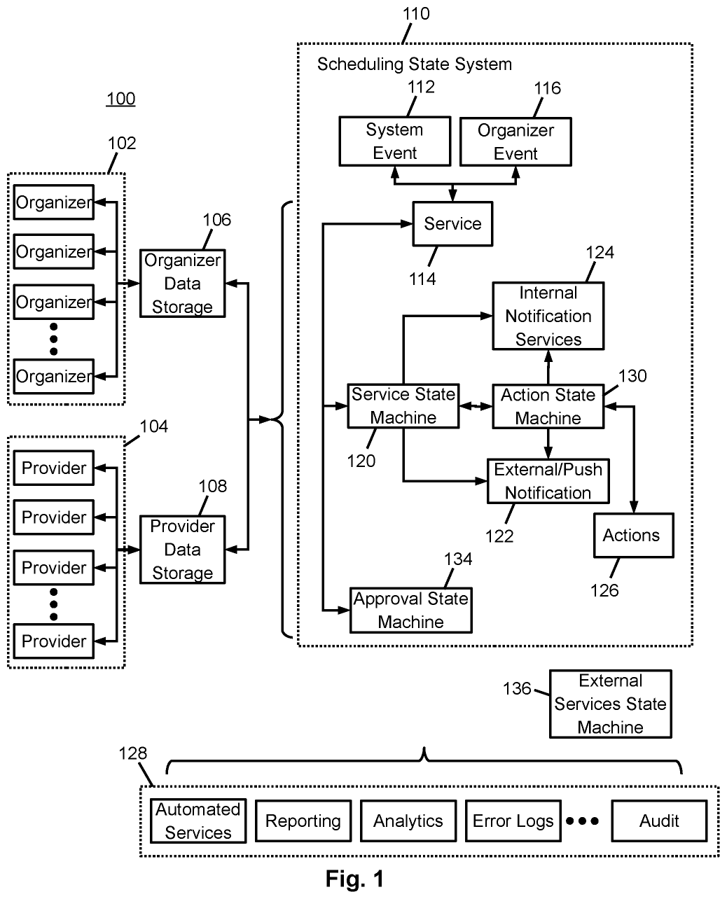

FIG. 1 is a logical diagram illustrating an event scheduling management system 100 according to some embodiments. The system 100 may be, for example, a platform that links one or more organizers 102 to one or more providers 104 by providing organizer data storage 106 and provider data storage 108, which in turn, are used by a scheduling state system 110. The scheduling state system 110 uses data from the organizer data storage 106 and provider data storage 108 to provide a chain of state machines for controlling scheduling of an organizer event 116 or scheduling system events 112 such as a celebratory event.

An organizer 102 may create an organizer event, and data for the organizer event, and about the organizer 102, organizer preferences, requirements, and the like, may be stored in the organizer data storage 106. An organizer event 116 may be, for example, a celebratory event such as a wedding, engagement party, family reunion, quinceañera, a bar/bat mitzvah, a birthday party, or the like. Alternatively, an organizer event may be a business event such as a company meeting, a convention, a trade show, a sales meeting, a training event, or the like. However, while organizer events are described herein as various types of celebratory events or business events, the type of organizer event 116 is not limited, and may be any type of organizer event 116. An organizer event 116 is an event with which one or more services 114 are associated. Each service 114 has one or more associated actions 126.

The services 114 are services provided by various providers 104. Each provider may provide data on their respective services 114 for storage in the provider data storage 108. Each event organizer 102 may specify an organizer event 116, and may store information about the organizer event 116 in the organizer data storage 106, and then select or book one or more services for their respective organizer event 116.

The management of a schedule for an organizer event 116 is provided by a service state machine 120 for each service 114 of the organizer event 116, and by an action state machine 130 for each action of each service 114.

Thus, an organizer event 116 may have one or more associated services 114, with a service state machine 120 for each service 114. Each service state machine 120 runs independently of other service state machines 120 for the organizer event 116. Additionally, each service state machine 120 has one or more associated actions 126, and an action state machine 130 for each action 126. A service state machine 120 may control which action state machine 130 is running, and verify that a particular state machine has completed the associated action 126 before starting the next action state machine 130 to execute the next action 126. Thus, each service state machine 120 controls one or more action state machines 130 to cause the action state machines 130 to run in sequence so that each action 126 is performed in sequence. Thus, the actions for a service may be set to be contingent on each other, with the service state machine 120 requiring that each action be complete, and the associated action state machine 130 terminated, before a new action 126 and associated action state machine 130 are started.

In some embodiments, the scheduling state system 110 also has one or more approval state machines 134 that permit authorization of a service state machine 120 startup. In some embodiments, service state machine 120 may be associated with a single service 114, and a separate approval state machine 134. In some embodiments, a single approval state machine 134 may be associated with multiple services and used to authorize starting multiple service state machines 120. The approval state machine 134 may be associated with booking a selected service 114, and may have states associated with approval for the service by each party, such as the provider 104 providing the service 114 and the organizer 102 booking the service. For example, an approval state machine 134 for a catering service may have actions associated with the organizer 102 requesting a booking, the provider 104 accepting the booking, and the organizer 102 or provider 104 providing a final approval on the booking. Once the approval state machine 134 terminates with a finished, done, approved, or other affirmative status, the approval state machine 134 may provide an indication permitting the service state machine 120 to start. However, while the approval state machine is active, or is stopped with a pause, terminate, cancel, or other negative status, the service 114 may be blocked, and the associated service state machine 120 prevented from running.

In some embodiments, the system 100 may track one or more scheduling system events 112 that may be triggered by a service 114, or that may be used to set states or states in a service state machine for a service 114. For example, the system 100 may track triggers or schedules for scheduling system events 112 for calculations and data processing such as audit calculations, integration activities such as responding to third party automated systems, and the like. The scheduling system events 112 may be provided by organizers 102, providers, agents or related parties for either an organizer 102 or provider 104, or the like. For example, an organizer may provide information for a wedding registry at an integrated third party website, and the system 100 may create a scheduling system event that periodically retrieves updated wedding registry information for use by the system 100. In some embodiments, the scheduling state system 110 may provide internal notifications 124 and external or push notifications 122. The internal notifications 124 may include messaging from service state machines 120 or action state machine 130 related to the status of a state machine 120, 130, a change in status or state of a state machine 120, 130, completion or running by a state machine 120, 130, date or action reminders, or the like. In some embodiments, the external push notifications 122 may be messaging provided to external parties regarding reminders, statuses or status changes for a state machine 120, 130, or the like. For example, in some embodiments, for a catering service 114, an action may require approval of a menu or pricing by an organizer 102, and when the organizer 102 provides the required approval, the approval action is completed, and a message may be sent to the provider 104 that approval has been received. Additionally, the provider 104 or organizer may be notified of a next action. For example, once approval for a menu is received, the next action 126 may be confirming head count, and the external push notification 122 element may send the organizer 102 a notification, as an interface notification, an email a push notification through a mobile app, or the like, that headcount confirmation is required.

In some embodiments, the system 100 may also provide one or more external services state machines 136 that may be used as state machines for external actions. For example, the external services state machine 136 may track states of different services by receiving status updates, or for integration into the services 114 being provided through the system 100. Thus, the external services state machine 136 may act as an application programming interface (API) that third parties may integrate with to provide state data for services 114 or organizer events 116. The system 100 may also provide data for one or more supplemental services 128 such as automated service, reporting, analytics, error logs, audit logs, and the like.

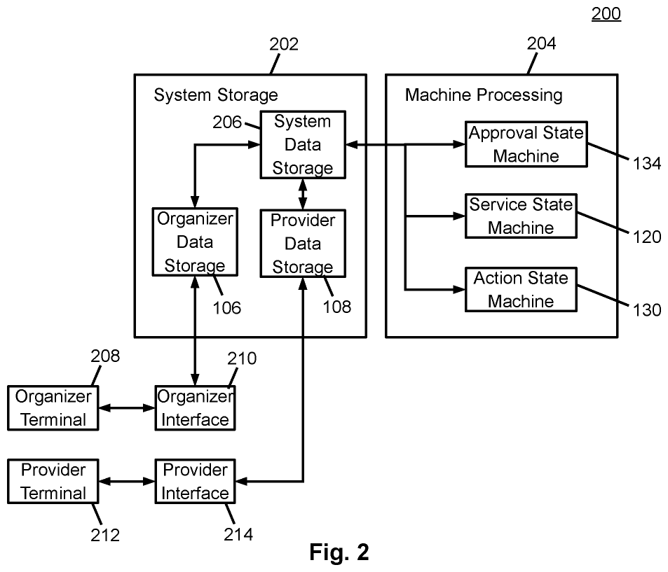

FIG. 2 is a logical diagram illustrating a data arrangement 200 for providing a scheduling management system according to some embodiments. The data arrangement 200 may be provided by one or more servers with processors running computer instructions stored on non-transitory computer readable mediums. The data arrangement 200 may include an organizer interface 210 that is provided to an organizer terminal 208. In some embodiments, the data arrangement 200 may also include a provider interface 214 that is provided to a provider terminal 212. The organizer terminal 208 and provider terminal 212 may each be a hardware device, software system or the like, such as a mobile phone, personal computer (PC) kiosk, website, web browser, mobile application, or the like. The organizer interface 210 allows an organizer to use the organizer terminal 208 to interact with organizer data storage 106 of a system storage element 202. Similarly, the provider interface 214 allows a provider to use the provider terminal 212 to interact with provider data storage 108 of the system storage element 202.

The system storage element 202 may be one or more databases, data stores, files, or the like, and may be used to store data for tracking organizer events, available services, and associated actions, state machines, messages, or the like. The organizer data storage 106 may store data related to individual organizers, such as organizer events, selected services and the associated service state machines, action and action state machines, and the like. The provider data storage 108 may store data related to individual providers, such as services provided by a particular provider, actions associated with the provider's specific services, and details related to the services and actions, data for services and action state machines, and the like. In some embodiments, the organizer data storage 106 and provider data storage 108 are each part of an overall system database, and in other embodiments, may be one or more separate databases or data stores, and may interact with other databases such as a system data storage 206.

It should be understood that the databases, data stores, data storage, and other systems, programs, servers, clouds, services, devices, or the like are merely meant to represent entities that store data, and are not limiting. For example, the system storage element 202, the organizer data storage 106, and provider data storage 108 may each be a relational database, a non-relational database such as a NoSQL (not only structured query language/no structured query language) database using blob data, flat file, cloud storage system or other data stores system. Additionally, the system storage element 202, the organizer data storage 106, and provider data storage 108 may be in separate data storage systems, or may be disposed in a same data storage system.

In some embodiments, the system data storage 206 may store data related to, for example, approval state machines 134, service state machines 120, and action state machines 130. For example, the system data storage 206 may be one or more databases storing data related to the state of each state machine 120, 130, 134, the active actions of the service state machines 120, and the like. Additionally, the system data storage 206 may monitor data changes for the state machines 120, 130, 134. The system data storage may provide alerts, calendar updates, requirements for new active actions, and the like to the organizer data storage 106 and provider data storage 108 for display or communications to organizers and providers through, for example, the organizer interface 210 and provider interface 214, through external communications, or the like.

In some embodiments, the data arrangement 200 may further have a machine processing element 204 that implements state machines such as approval state machines 134, service state machines 120, action state machines 130, or other state machines. The machine processing element 204 may, in some embodiments, be processing, data and storage elements that track the requirements for the state machines 120, 130, 134, track the current state of the state machines 120, 130, 134, monitor data changes for the state machines 120, 130, 134, determine whether states for a state machine 120, 130, 134 are met, transition the state machines 120, 130, 134 between states, implement actions for the action state machines 130, and the like.

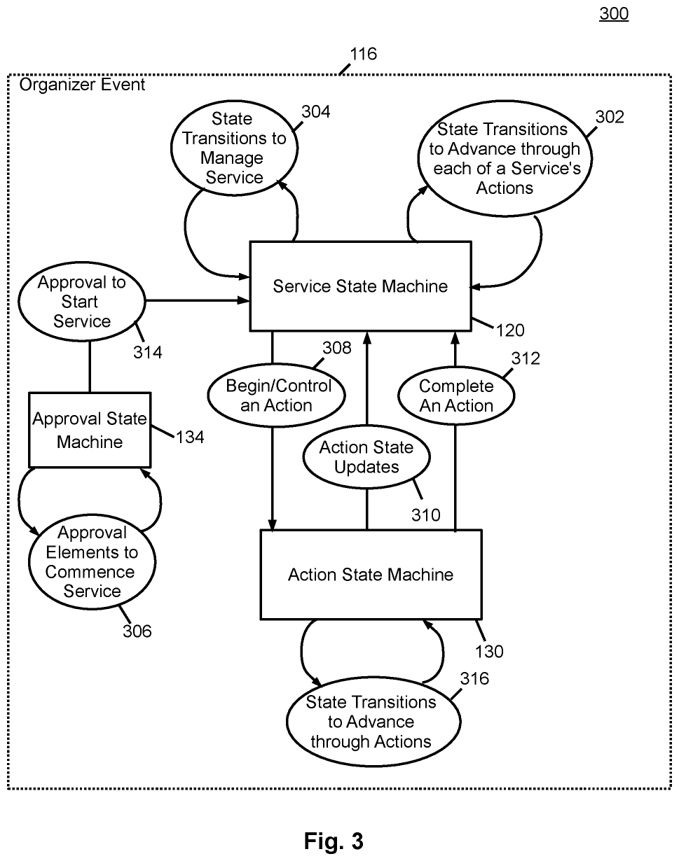

FIG. 3 is a logical diagram illustrating a scheduling management system 300 for an organizer event 116 according to some embodiments. While a single service state machine 120 is illustrated for the organizer event 116, it should be understood that the disclosed arrangement of the scheduling management system is intended to be exemplary, and that an organizer event 116 is not limited to a single service state machine 120, as a service may have one or more service state machines 120. Each service state machine 120 may be implemented independently so that multiple services may be traced and managed for an organizer event 116.

An organizer may identify or create an organizer event 116, and select one or more services for the organizer event 116. A service state machine 120 may be generated for each service, once the service is booked. In some embodiments, an approval state machine 134 may be associated with booking each service. The approval state machine 134 may have associated approval elements 306 that are specified by a provider before the service is considered booked. The approval elements 306 may include one or more actions or other requirements for a booking of a service to be approved. The approval state machine 134 may iterate through one or more of the approval elements before the approval state machine 134 ends and an approval to start the service 314 is generated. The approval state machine 134 may, for example, have approval elements 306 requiring a request for a booking by an organizer, and an acceptance of booking by the provider, or requiring a request for a booking by a provider, and acceptance of booking by the organizer. These approval elements 306 may be required in sequence, with each approval element 306 requiring completion of a previous approval element 306. In some embodiments, the approval elements 306 are identified by a provider so that the provider customizes the approval process for the individual service. The approval elements 306 may be specific to a provider, or may be predetermined approval elements 306 that are loaded, from, for example, a template, from another existing service, or the like. For example, a provider setting up a catering service may use a template for approval that requires approval elements including the organizer requesting a booking, the provider providing a quote for the service, approval by the organizer, verification of the event date by the provider, and acceptance of the booking by the provider. The provider may modify the number or order of the approval elements 306, add or remove approval elements 306, change requirements for the approval elements 306, or any other changes. For example, the provider may remove the approval element requiring verification of the event date by the provider, add an approval element requiring submission of a deposit by the organizer, or modify the approval requirement where the organizer requests a booking to include the organizer to include an estimated headcount in the request for the booking.

The action state machine 130 may be generated in response to an organizer requesting a booking, in response to the approval state machine 134 completing and generating an approval indication to start service 314, or in response to another system event or trigger. Each service may have one or more associated actions, and thus, the service state machine 120 for a particular service may control one or more action state machines 130, with each action state machine 130 associated with an action for the respective service.

The service state machine 120 may process one or more state transitions to manage the service 304. The state transitions to manage the service 304 may control whether the service 304 is inactive, running, stopped, paused, cancelled, ready to deliver, is done, or enters another state. For example, the service state machine 120 may be in an inactive state before the approval to start the service 314 is issued, and, once approved to start, may enter an active state. The service 314 may then be transitioned to a non-active state such as being paused, stopped, cancelled, complete or done, or the like. In some embodiments, while the service state machine 120 is active, the service state machine may transition states of the action and action state machines 130 through each of a service's actions 302. Thus, a state transition to a non-active state for the service state machine 120 may cause the service state machine 120 to control an action state machine 130, using, for example, an indication to begin or control an action 308, and that indication may be in the form of data, a message, or other indication. The action state machine 130, when active, performs state transitions to advance through a plurality of actions 316. The action state machine 130 may be associated with an action, or multiple actions, that require one or more steps or completion of one or more requirements before the action is considered complete. Once the action is complete, the action state machine 130 may enter a non-active state indicating that the action state machine 130 is in a done, complete, or delivery ready state. In some embodiments, the action state machine 130 sends action state updates 310 when the state of the action state machine changes, and may send an action complete message 312 when the action state machine 130 enters the non-active state. Thus, the action state machine 130 may indicate to a parent or controlling service state machine 120 that the action associated with the action state machine 130 is complete or ready for delivery so that the service state machine 120 may start a next action state machine 130 to process a next action. The service state machine controls the execution of one or more action state machines 130 to enforce linearity of action performance and ensures that identifiable steps or actions for handling services and events are addressed in controllable fashion and order.

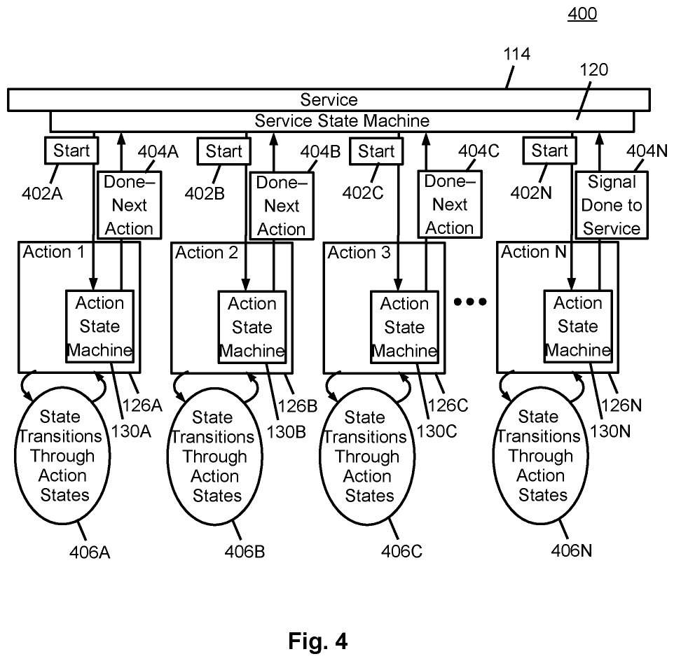

FIG. 4 is a diagram illustrating handling of multiple action state machines 130A . . . 130N by a service state machine 120 according to some embodiments. The service state machine 120 may be one service state machine 120 of a plurality of service state machines 120 and may be associated with a service 114 that is a service 114 of a plurality of services 114 selected for an organizer event.

In some embodiments, a plurality of actions, or service actions 126A . . . 126N, are associated with a service, or the service 114. When the service 114 is created, a service state machine 120 may be created to handle action state machines 130A . . . 130N associated with the service actions 126A . . . 126N. In some embodiments, the action state machines 130A . . . 130N may be created when the service state machine 120 is created. The service machine 120 may, in some embodiments, be started in response to an approval state machine successfully completing, in response to a manual command from an organizer or a provider, in response to a date or deadline occurring, in response to one or more messages sent through the system, or in response to another cue or message.

In some embodiments, the service state machine 120 provides a start message 402A . . . 402N to a selected action state machine 130A . . . 130N associated with a service action 126A . . . 126N. The selected action state machine 130A . . . 130N performs state transitions though action states 406A . . . 406N, including permitting the service action 126A . . . 126N. Once the service action 126A . . . 126N is completed, the action state machine 130A . . . 130N indicates, by way of a done indication 404A . . . 404N that the service state machine 120 may move to the next action 126A . . . 126N. The service state machine 120 may then start the next action state machine 130A . . . 130N. Additionally, when a last action state machine 130A . . . 130N completes the state transitions and associated action 1226A . . . 126N, the service state machine 120 may interpret the done indication to be that the action state machine 130A . . . 130N is done, or ready for delivery.

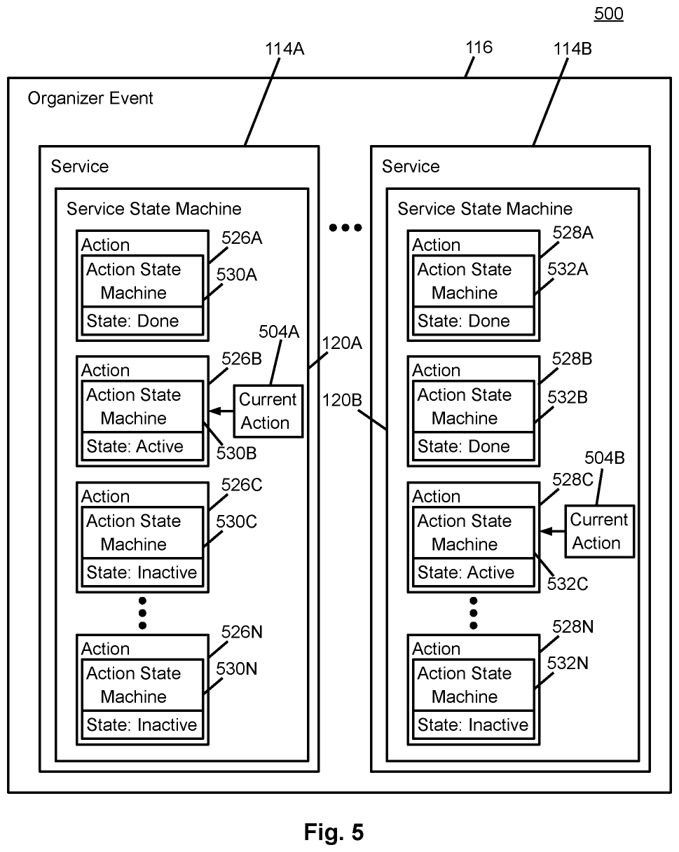

FIG. 5 is a diagram illustrating a logical structure 500 for storing data related to an organizer event 116 according to some embodiments. Data for an organizer event 116 may be stored in, for example, a database that permits organizer events 116 to be associated with one or more services 114A . . . 114B to be associated with each organizer event 116. Additionally, while services 114A . . . 114B are shown depending directly from a top-level organizer event, an organizer event 116 may have one or more dependent organizer events that act as sub-events, and the events may be nested to any level so that services 114A . . . 114B may be organized in groups to differentiate the services for different organizational elements.

Each service 114A is associated with a service state machine 120A . . . 120B that implements actions 526A . . . 526N, 528A . . . 528N by controlling associated action state machines 530A . . . 530N, 532A . . . 532N. For example, a first service 114A may be associated with a first service state machine 120A, and a second service 114B may be associated with a second service state machine 120B. Actions being completed or triggered by outside events advances the service state machine 120A . . . 120B to activate or start subsequent action state machines 530A . . . 530N, 532A . . . 532N. The service state machines 120A . . . 120B may each have one or more associated actions 526A . . . 526N, 528A . . . 528N that are different from the actions 526A . . . 526N, 528A . . . 528N for other service state machines 210A . . . 210B. Thus, each service state machine 120A . . . 120B may operate independently, and handle the action state machines 530A . . . 530N, 532A . . . 532N for the respective service state machine 120A . . . 120B independently of the other service state machines 120A . . . 1210B. Thus, in some embodiments, the first service state machine 120A has first actions 526A . . . 526N associated with first state machines, and may run the first action state machines 530A . . . 530N separately from the second service state machine 120B running the second action state machines 532A . . . 532N associated with the second actions 528A . . . 528N of the second service state machine 120B.

Each of the action state machines 530A . . . 530N, 532A . . . 532N tracks a current state of the respective action state machines 530A . . . 530N, 532A . . . 532N, and the service state machine 120A . . . 120B may have a current action indicator 504A . . . 504B that indicates an action that is active, in an active state, running or otherwise being executed. For example, a first action state machine 530A of the first service state machine 120A may be completed, and thus, may be in a done state. The second action state machine 530B of the first service state machine 120A may be the current action and may be in an active state. The third action state machine 530C and subsequent action state machines 520N of the first service state machine 120A may be in an inactive state as a result of not being started due to being associated with actions 526C . . . 526N that will be performed after the second action 526B. Thus, the first service state machine 120A would have a current action indicator 504A that indicates that the second action 526B is the current action and that the second action state machine 530B is the currently executing or active action state machine for the first service state machine 120A. Similarly, the second service state machine 120B has a second current action indicator 504B that indicates that a third action 528C is the current action, or that the third action state machine of the second service state machine 120B is the currently executing or active action state machine for the second service state machine 120B.

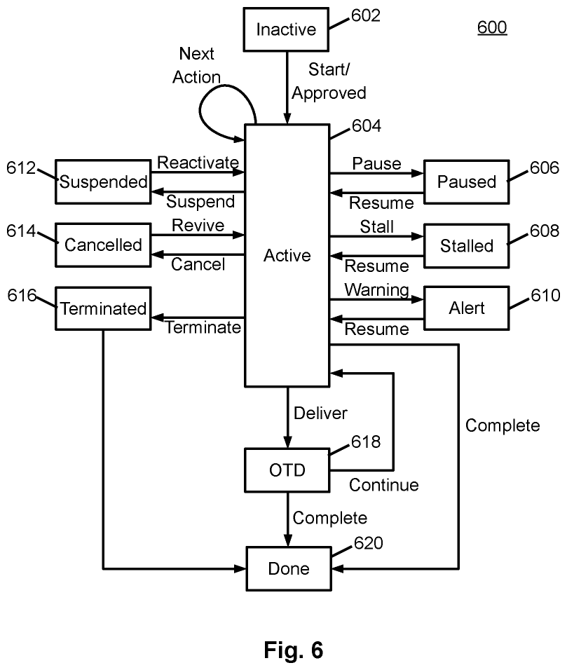

FIG. 6 is a diagram illustrating a state arrangement 600 for a service state machine according to some embodiments. In some embodiments, a service state machine may be instantiated, generated, designated, or otherwise created, and may have data indicating a state stored, for example, in a database, or other data store. Code executing the service state machine may retrieve state data indicating the current state of the service state machine. Additionally, the service state may initially start in an inactive state 602. The inactive state 602 may be designated by a template, or other indication or selection from a provider. The service state machine may stay in the inactive state 602 until triggered by a message, change in data in a database, completion or authorization from an approval state machine, a manual start message, or another message or indication. For example, an approval state machine may post a data value to a database entry for the service state machine, or may send a message to an instantiated state machine, that indicates that the service is approved to start. Once the service state machine is authorized to move out of the inactive state 602, the service machine enters the active state 604. While in the active state 604, the service state machine permits one or more action state machines to run, and in some embodiments, controls a plurality of action state machines to run in sequence or in a specified order. Thus, while in the active state 604, the service state machine controls an action state machine to start, and waits for the started or active action state machine to run or execute an action and provide an indication that the action state machine is complete or done. Once a running action state machine indicates that it is complete or done, the service state machine starts the next action state machine, and repeats the process until the service state machine determines that the last action state machine has completed.

The service state machine runs action machines sequentially while the service state machine is in the active state, but the service state machine may be put into a non-active state to stop the execution or running of the current action state machine. For example, the service state machine may be put into a suspended state 612, a cancelled state 614, a paused state 606, a stalled state 608, or an alert state 610 in response to the service state machine receiving a state transition indication such as a message, data or the like. In some embodiments, the service state machine may also transition back to the active state 604 from the non-active state by an appropriate data transition indication, and may resume the active action state machine.

In some embodiments, the service state machine may transition from an active state to a terminated state 616 in response to receiving a terminate state transition indication, and may then transition to a done state 620. When the service state machine transitions to a non-active state, or to the terminated state 616, the service state machine may stop, pause, cancel, or suspend or otherwise permanently or temporarily transition the active state machine from an active state. For example, when the service state machine receives a message to suspend the service state machine, the service state machine may transition to the suspended state 612, and may provide a state transition indication for an active action state machine to cause the action state machine to change to the suspended state as well. Similarly, when the service state machine is in the suspended state 612 and receives a reactivate state transition indication, the service state machine transitions to the active state 604, and provides a state transition indication for an active action state machine to cause the action state machine to transition to the active state 604. Thus, the service state machine may track the active action state machine, and may control the state of the active action state machine using state transition indications.

Once each of the action state machines completes, the service may be ready to deliver, and may transition to an on-the-date (OTD) state 618, and may wait for confirmation of delivery, approval, payments, or another confirmation that the service is acceptably completed. After the OTD state 618 completes, the service state machine may transition to the done state 620. In some embodiments, a service OTD date is a target date set for a service, and may be set, for example, by contract or other agreement. Actions for the service may have OTD dates or deadlines that are before on, or after the service OTD date. The service OTD date is associated with completion of a contracted set of actions, regardless of whether the actions have OTD dates that are later than the service OTD date. For example, a service may have actions, such as cleanup,rental pickup, deposit return, final bill settlement, and the like, that may take place after an event scheduled on the service OTD date. Thus, the service OTD state 618 permits action state machines to keep running by letting the service state machine continue after entering the OTD state 618, with the service state machine able to re-enter the active state 604 from the OTD state 618.

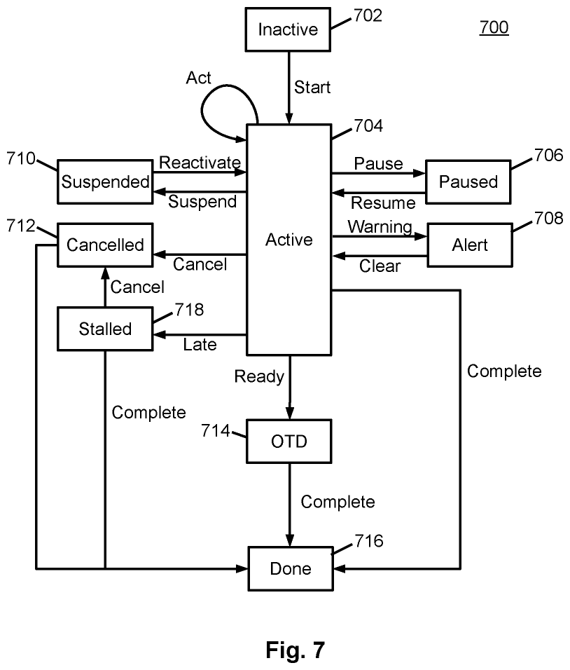

FIG. 7 is a diagram illustrating a state arrangement 700 for an action state machine according to some embodiments. In some embodiments, an action state machine may be instantiated, generated, designated, or otherwise created, and may have data indicating a state stored, for example, in a database, or other data store. In some embodiments, a service state machine may determine each action needed to perform the service, and may generate multiple action state machines, with an action state machine for each required action, defaulting each action state machine to an inactive state 702 until the action state machine is needed or set as the active action state machine. In other embodiments, the service state machine may create or instantiate an action state machine for an action when the service state machine prepares to use the action as the current action. In yet another embodiment, the service state machine may generate or instantiate a single action state machine, and reuse the same action state machine for each action by associating an active action with the action state machine, and changing the action associated with the action state machine when a preceding action is completed. Thus, once the action state machine is set to a done state 716, the action associated with the action state machine may be changed. In some embodiments, after the action state machine is reused by changing the action associated with the action state machine, the state of the action state machine may be reset to the inactive state 702. Additionally, where the action state machine is changed to be associated with an action that does not require an additional start indication or approval to restart the action state machine, the state of the action state machine may be reset to the active state 704.

In some embodiments, the state of an action state machine may be initially set to the inactive state, and may transition to the active state 704 when the action state machine receives, from a parent service state machine, a state transition indication to activate, run or otherwise start the action state machine.

The action state machine may run or act on actions while in the active state 704, and once the action is complete, may indicate that the action is ready for delivery, ready, or otherwise finished, by transitioning to an on-the-date (OTD) state 714. Code handling the action state machine may monitor for changes to a database, may loop through steps that continuously check for approval, or may wait for a message or other indication of approval, or may implement running of the action using another process. For example, an action may be to receive approval for a catering menu. The action may include sending a message such as a notification or reminder to an organizer, and one or more follow up messages, if needed, and then waiting for a response, or other indication signaling approval of the catering menu.

In some embodiments, different actions may have different responding or responsible parties, may be associated with dates or other actions, and may be associated with receiving action data indications, such as message, approvals, selections, verifications, or other data indicating that an action has been completed. For example, an action may be for a florist and may have a deadline or reminder for ordering the required materials for a flower delivery service, with the action being triggered by approval of flower arrangement plans in a previous action. The action may be that the florist needs to order flowers by a particular date, and may include inserting a calendar reminder to add the selected flowers to a wholesale order. If a deadline date to verify that the flower order has been placed passes without the action being completed, the action may include sending a reminder on the flower order. Once a verification is provided by the florist that the flowers have been ordered, the action completes, and the action state machine transitions to the OTD state 714 to indicate that the action is ready, ready for delivery, ready for integration into an overall service, or otherwise at a finished state prior to being done.

While the action state machine is in the active state 704, the action state machine may receive a state transition indication to transition to a non-active state such as a suspended state 710, cancelled state 712, paused state 706, alert state 708, stalled state 718, or the like. The state transition indication may be sent by the parent service state machine as a result, for example, of the service state machine being put into a non-active state or according to another trigger, system event, or the like. The stalled state 718 may be a state indicating that a particular action has passed a deadline without appropriate action. Thus, the action state machine may monitor for completion of an action, and when a particular deadline passes, or a threshold associated with a deadline, the action state machine may determine that the action is late, and may transition the action state machine from the active state 704 to the stalled state 718. Entering the stalled state 718 may include triggering one or more warning, notifications, message, or the like. Additionally, the action state machine may transition from the stalled state 718 to the cancelled state 712 in response to passage of another deadline indicating that an event or action is no longer valid, an indication that the action has been cancelled, a lack of response within a predetermined time period, or the like. Alternatively, the action state machine may transition from the stalled state 718 to the done state 716 in response to receiving an indication that the action has been completed. In other embodiments, the action state machine may transition from the stalled state 718 to another state such as the OTD state 714 or the active state 704 to continue performing the action, or to wait for additional deadlines or action elements.

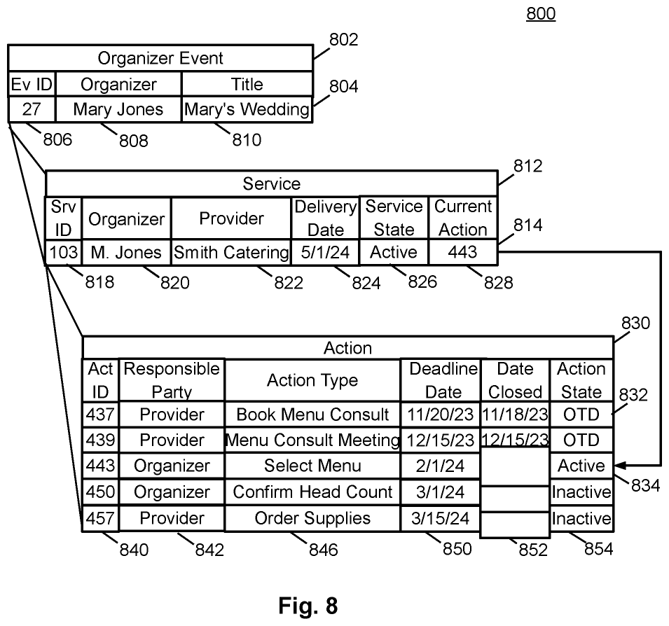

FIG. 8 is a logical diagram illustrating a data relationship arrangement 800 according to some embodiments. In some embodiments, data for organizer events, services, and actions may be stored in tables, for example, of a database, or in data stores, blocks, as unstructured data, in files, or in other forms. Thus, persistent data may be stored in a relational database, a non-relational or NoSQL database, in an object-oriented database, in an in-memory data structure store such as a memory cache, hybrid database, or any other type of data storage. The data may be related to services, or may link services and associated actions. For example, an event table 802 may have one or more event entries 804 identifying a particular organizer event. Each event entry 804 may have fields for data associated with the organizer event represented by the event entry 804. In some embodiments, an event entry 804 may have an event identifier (ID) 806, organizer data 808, and additional data 810, such as a title, date, or other event specific data. The event ID 806 may be a unique identifier, such as an ordinal globally universal identifier (GUID), universally unique identifier (UUID), or other identification data. In embodiments where the data is stored in a relational database, the event ID may be a key value or other value by which other tables or data entries reference a particular event entry 804.

In some embodiments, the events identified in each event entry 804 may be stored as objects in, for example, a NoSQL database, and may be stored as blob data, along with one or more sub-elements such as services and actions. Thus, for a non-relational database, provider events and associated services and events are handled as objects, and may be embedded in each other. Embedding the objects in a parent object implicitly creates a relationship between an object and its parent. In some embodiments, the non-relational database allows the top level object to be stored with all of the embedded objects as object data, and objects themselves are embodied in other objects and stored as a data structure. The IDs of parent objects may be handled implicitly by the database, or may be explicitly handled.

In some embodiments, the arrangement 800 may also have a service table 812 with one or more service entries 814. Each service entry 814 may have data fields that identify the service. The service entry 814 may also have additional data fields such as a service identifier 818, organizer data 820, and provider data 822 that identify the service, the organizer and the provider for the service. In some embodiments, the service entry 814 may also have data fields such as deadline or delivery date data 824 that identifies a deadline for the service, and which may be used to verify that service actions are performed in a timely manner. The service entry 814 may also have service state data 826 related to the state of the service and a current action identifier 828. In some embodiments, the service state data reflects the state of the service associated with the service entry 814 so that a service state machine may be restarted, created, or otherwise generated from the service entry 814 in case of a service interruption, and avoid relying on the service state being maintained solely in the service state machine. Similarly, the current action identifier may be used to track an action that is currently active to avoid relying solely on an action state machine or action entry 832 for tracking progress of the service. In some embodiments, the arrangement 800 may also have an action table 830 that has one or more action entries 832. Each action entry 832 may have identification data such as action ID data 840. The action ID data 840 may uniquely identify the action entry 832. This permits multiple action entries 832 to be uniquely identified and associated with a single service entry 814 so that a service state machine can sequentially, or concurrently, run one or more action state machines, with each action state machine associated with the action for a different action entry 832. In other embodiments, the event entries 814, service entries 814 and action entries 832 may be stored in a relational database and one or more of the entries may include data linking that entry to a parent entry. For example, a service entry 814 may have a parent ID or event ID that identifies, for example, the ID of a particular event entry 804, linking or associating the service and service entry 814 to a particular event and event entry 804. Similarly, each action entry 832 may include service ID data, event ID data, and the like, that references a parent service or event. Service ID data of a particular action entry 832 may reference service ID data of a service entry 814, and event ID data of the action entry 832 may reference event ID data 806 of an event entry 804.

In some embodiments, the action entry 832 may have responsible party data 842 associated with a party, such as the organizer, provider, or another party, that is required to approve or complete the action. Thus, an action state machine may determine from the responsible party data 842, whether reminders should be sent, what party is authorized to complete or provide data related to the action, or the like. Additionally, the action entry 832 may also have action type data 846 indicating the type of action, and either directly or indirectly, indicating what steps or elements need to be performed for a particular action entry. For example, booking a catering menu consultation-type action may require either a calendar entry from one or both parties, or a confirmation that the booking was made, and a menu consultation meeting-type action may only be associated with a deadline or meeting appointment, permitting a responsible party to confirm that the meeting occurred. In contrast, a menu selection-type action may require submission of a menu, or confirmation from one or more parties that a menu has been submitted. For example, in some embodiments, a provider may have a menu selection interface or a calendar interface associated with the service state machine, the interfaces providing the ability for an organizer to schedule a meeting or select a menu, and the interfaces providing an automated message to the relevant service state machine or action state machine to confirm that the requirements of the relevant action have been met. In other embodiments, a party, such as the provider, may provide a confirmation message to the service state machine or action state machine, indicating that a meeting has been scheduled or a menu set, so that the action state machine is able to complete the associated action and cause the service state machine to advance to the next action.

In some embodiments, the action entry 832 may have deadline data 850, action close data 852, and action state data 854. The deadline data may be related to the delivery date data 824 of the related service entry, and may be used to set alerts for late actions, trigger sending of reminders, and the like. For example, an action state machine may determine that an action has an approaching deadline for which an approval is needed, and may send a reminder three days before the deadline occurs. The action closed data 852 may be used for audit and tracking, to verify that an action was closed, or is ready for delivery. The action state data 854 identifies the state of each action, and permits an active action entry 834 to be identified outside of the service entry 814. Additionally, while not shown, action entries 832 may include other data including, but not limited to, action order data indicating which of the related actions should occur next, or an order in which the related actions for a service should occur, data related to reminders already sent, notes form different parties, elements of an action and respective status, or other data.

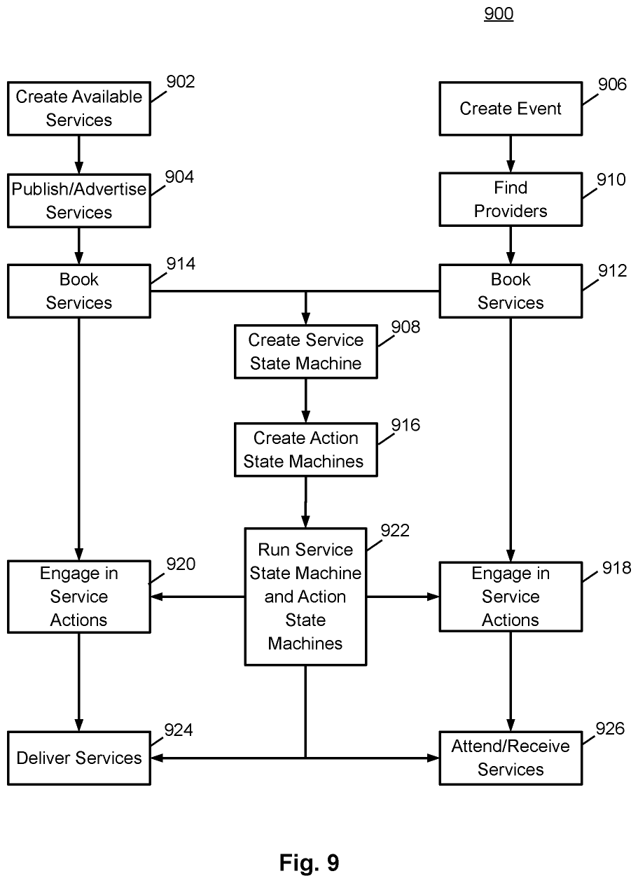

FIG. 9 is a flow diagram illustrating a process 900 for providing events and services, and executing the state engines for managing the services according to some embodiments. In block 902 a provider, who is registered with the system, creates one or more available services. The service creation may include generating entries and information for display to a user for selection from a list of available services. In block 904, the provider may publish or advertise the services by, for example, approving the created services for publication, by buying advertising, promoting and marketing the service, and the like. In block 906, an organizer may create an event under which they wish to book one or more services. Data related to the event may be saved as, for example, an event entry, along with data specific to the event, such as an event date, type of event, or the like.

In block 912, an organizer may book a service. The organizer booking the service may include requesting information on a selected service, providing date and event information, requesting a quote, specifying what elements of a service are desired, and the like. In block 914, the provider may book the service. The provider may interact with the organizer to provide information such as quotes, and the like based on the organizer's event information or request for services. Once the organizer and provider agree to book the service, data may be stored in a database to permit creation of the service state machines in block 908. The service state machines may be created and populated with data from a database, including identifying one or more actions for the service. In block 916, one or more action state machines are created, instantiated, or otherwise made usable. The action state machine may be associated with the actions identified by the service state machine, and may, for example, be actions listed in an action table and associated with a service entry in a database. In block 922, the service state engine and one or more action state machines may be run, or transitioned to an active state. The action state machines run or execute the actions associated with the service, and may, in some embodiments, prompt users for data or for confirmations that action elements have been performed.

In block 920, a provider engages in service actions, and in block 918, an organizer engages in service actions. Engaging in service actions may include responding to prompts or reminders for information from one or more action state machines, or providing confirmations, information, or other data to one or more action state machines to complete requirements and elements for actions. After each of the action state machines is finished or moved to a delivery ready-to-deliver state, a provider may deliver the agreed-upon service in block 924. In block 926, the organizer may receive the purchased service or attend a selected service-supported event.

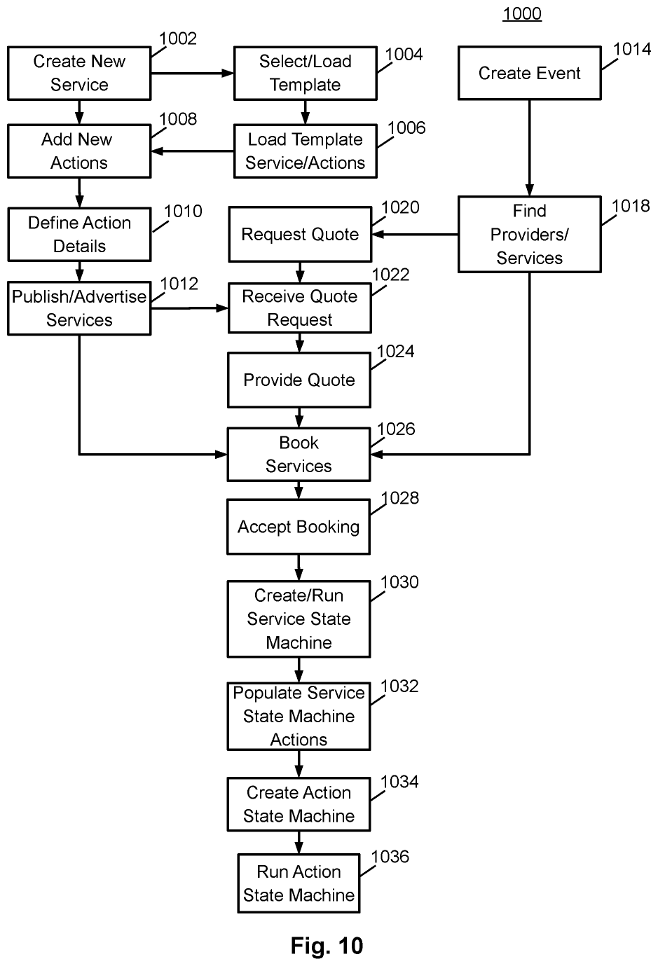

FIG. 10 is a flow diagram illustrating a method 1000 of using a scheduling management system according to some embodiments. In some embodiments, a provider may create a new service on block 1002. The provider may be registered with the system, and may enter data related to a service that the provider wants to make available for booking. In some embodiments, a provider may create their own service and actions by manually entering the data such as descriptions, deadlines or timelines, requirements or elements, relationships between actions and services, and the like. In some embodiments, the provider may opt to use predetermined services or related actions and populate a database with related actions by selecting and loading a template in block 1004. The template may include data such as description data, and related actions that may be used as the basis for customizing the actions for the provider's newly created service. In block 1006, the template for the service and the associated actions may be loaded into, for example a database, and may be associated with the newly created service. In block 1008, the provider may add new actions, or may modify, delete, rearrange, or other customize the actions to provide a desired set of actions, and a desired order for actions. For example, a rental provider may wish to provide a rental service for party furniture such as tables, chairs, linens and outdoor enclosures such as tents. The provider may create a listing for the party furniture rentals, and then may select or load a template that permits the provider to view the actions or steps in a default service. The provider may select to use the selected template, and may save the template, and associated actions, in a database, with the actions associated with the service.

In block 1010, the provider may define details for each of the actions. The provider may set elements required for each action, such as parameters, data requirements, the party responsible for completing the action, a deadline or deadline data, or the like. For example, the provider may customize the actions by requiring that an estimated head count or number of furniture items to be rented is provided before a finalized quote is generated. Thus, while the provider may have already have had an action associated with providing an estimated quote for the party furniture rental, the provider may add an additional headcount/item count action and a final quote action, and may require that the additional headcount/item count action be performed before the final quote action. Additionally, the provider may enter deadline data such as a lead time, for an action so that, when a date is set for the overall service, the deadlines for different actions may be automatically calculated based on the lead time. Thus, a baker may require a 21-day lead time for determining cake flavors and decorations in order to schedule ordering materials and baking of a cake, while a party rental company may only require a 3-day lead time for a final headcount and delivery instructions since the party furniture would likely already be in stock.

In another example, the additional headcount/item count action may be created with the organizer as a responsible party, and may trigger an interface to provide a prompt to the organizer in the organizer interface to get that data from the organizer. For example, the provider may have a list of available furniture items shown to the organizer in the organizer interface, and when the organizer enters the final headcount, or item counts desired, the system may automatically save that data, provide that data to the provider, and provide an action complete indication to the system so that the system completes or finishes the final headcount action, and changes the current action for the party rental service to the final quote action, or another next action.

In block 1012, the provider may elect to publish or advertise the newly created service. Thus, the system may add the service to a list of services available for display to an organizer.

In block 1014, an organizer creates an event. The organizer may enter event details such as a title, potential guest count, date, location, and the like, though the organizer interface. Details related to the event may be saved in a database so that services and actions have a common parent element in the database.

In block 1018, an organizer finds one or more services or providers for a particular service. Available services may be provided in the organizer interface, and may be presented in a list resulting from a search, through advertising, or the like. The available services may be a result of services that are published or advertised in the system by providers. Once a service is selected, the organizer may request a quote in block 1020. Requesting a quote may include submitting a quote request, that requests pricing, availability, booking information, or other information for a selected event, and may include submitting service request details such as headcount, location, date, services requested, and the like. For example, a wedding planner may request a quote for a baker to make a bride's cake for 300 people, for a particular date, and for delivery to a particular venue. In another example, an organizer may request a quote for catering for a business meeting, with a headcount, location and date, and a potential menu, if known.

In some embodiments, the parties may engage in an optional quote process. For the quote process, the provider, in block 1022, may receive the request for the quote, and in block 1024, the provider may provide the quote based on data in the quote request. In block 1026, the organizer may book the service. In some embodiments, the booking of the request may be based on the quote, or may be based on other agreed-upon details. Once the quote process in blocks 1020, 1022 and 1024 is performed, either the provider or the organizer may book the service in block 1026, and the other party may accept the booking in block 1028.

In other embodiments where the parties do not go through the quote process, the organizer may create an event in block 1016, or find a service in block 1018, and may directly book the service in block 1206without requesting or receiving a quote in blocks 1020 and 1024. In block 1028, the provider may accept the booking requested by the organizer. Alternatively, the provider may book the service in in block 1026 after setting up the service, and the organizer may accept the booking in block 1028.

Once the booking is accepted, a service state machine is created and run in block 1030. In block 1032, the service state machine actions are populated. The actions used to populate the service state machine may, in some embodiments, be the actions created or customized by the provider. In block 1034, one or more action state machines are created for the actions of the service state machine. In block 1036, the service state machine runs the action state machine. In some embodiments, the service state machine controls running of the at least one action state machine to perform the plurality of actions in sequence. In some embodiments, running the action state machine includes the service state machine setting a state of each action state machine to an active state. Setting the state of the action state machines causes the action state machine to perform elements associated with a respective action associated with the respective action state machine while the state of the respective action machine is active. The service state machine sets the state of each action state machine according to an order of the actions, and at least one action has an element that comprises receiving an action performance indication from the organizer.

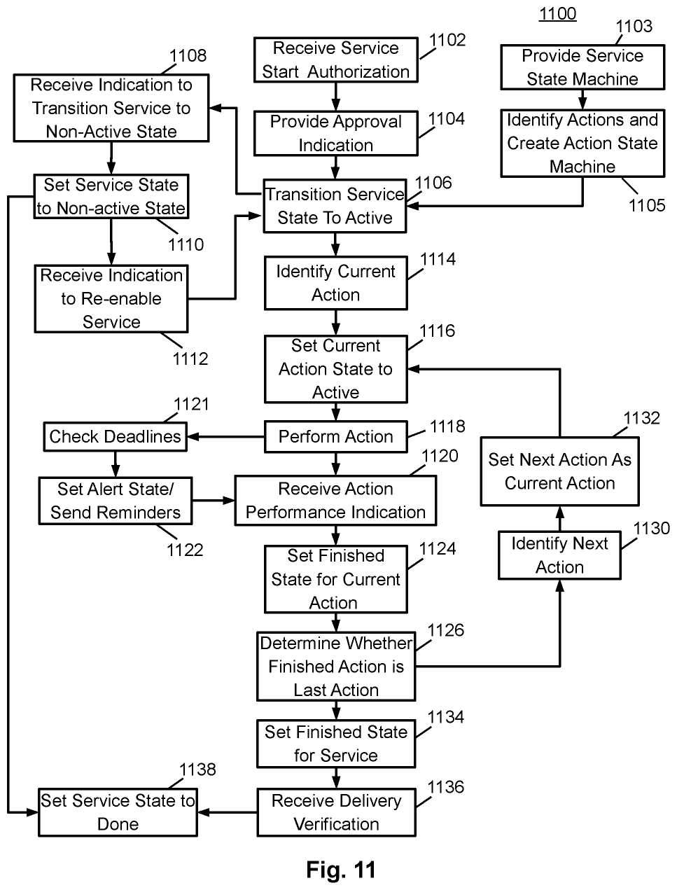

FIG. 11 is a flow diagram illustrating a method 1100 of running a scheduling management system according to some embodiments. In block 1103, a service state machine is provided. In some embodiments, the service state machine is provided by a scheduling management system, and is generated or otherwise provided in response to a service being created. In block 1105, one or more actions are identified, and one or more action state machines are created. The actions may be a plurality of actions associated with the service and identified by the provider prior to the service state machine being created. The actions may be actions loaded from a database. Each of the actions may have one or more elements that indicate interactions, data, message, or other indications from a responsible party that are required to complete the element in order to finish or otherwise complete an action.

In block 1102, service start authorization is received. In some embodiments, the service start authorization is received by an authorization state machine, and may be an acceptance of a booking, a booking approval, a message from an organizer or provider, or other indication. In block 1104, an approval indication is provided. In some embodiments, the approval indication may be a message generated by the approval state machine in response to the approval state machine completing or finishing. The approval indication may be sent to a service state machine and may cause the service state machine to transition to an active state in block 1106.

In some embodiments, the service may be put into a non-active state such as a paused state, or the like. Thus, in block 1108, the service state machine may receive an indication to transition the service state machine to a non-active state. In block 1110, the service state, or state of the service state machine is set to the nonactive state. The service may then be terminated, or may be restarted. Thus, in block 1112, the service state machine may receive an indication to re-enable the service, and then, in block 1106, the service state may be transitioned to active, and the process of running the service state machine may be continued.

The service state machine controls running of the action state machines to perform the actions in sequence. In block 1114, a current action is identified. In some embodiments, the first action that is not already completed in the order of actions may be the current action. In block 1116, the current action state is set to active. Thus, the state of the action state machine associated with the current action may have its state set to active. In block 1118, the system causes the current action state machine to perform the action associated with the current action state machine. In some embodiments, performing the action may include performing elements associated with the current action while the state of the current action is active. For example, performing the action may include receiving an action performance indication at the current action state machine. In some embodiments, performing the action may include executing elements of the actions, and may include providing, to a responsible party associated with the respective action, prompt data indicating to the responsible party to provide the action performance indication.

In block 1120, an action performance indication is received. The action performance indication indicates that an element associated with the action has been completed. The action performance indication may be a notification, message, or other data indicating that required data has been received to meet, complete or finish the required elements for the current action.

In some embodiments, performing the action may include waiting for a response or interaction from a party such as a provider or organizer. While waiting, an action state machine, or a service state machine, may cause the system to check deadlines associated with the current action in block 1121. In block 1122, the state of the current action may be set to an alert state, or one or more reminders may be sent regarding the action. Thus, an element of the action may include providing, to a responsible party associated with the respective action, according to a deadline associated with the action, a reminder to the responsible party to provide data regarding the action. The alert or reminder may be set according to the deadline, and may reflect the elements of the action. The alert or reminder may be, for example, a message, an email, a note provided in the provider interface or in the organizer interface, a text message, or another form of communications.

In block 1124, a finished state is set for the current action. Setting the finished state may include setting a state of the current state machine to a ready-to-deliver state, to an OTD state, to a done state, or to another state that is not active, but that indicates that the action does not need to be run. Thus, the state of the current action state machine may be set to a ready-to-deliver state in response to the action performance indication. The service state machine runs each of the actions in a specified order, with the order specified by, or approved by, the provider. In order to run the actions, the service state machine sets each action to the current action in sequence, and then performs the associated action. This repeats until the service state machine reaches the last action. Thus, in block 1126, the service state machine determines whether the current action that was just finished is the last action. The service state machine may determine, according to the order of the plurality of actions, whether a next action exists. If the most recently finished action or action state machine is not the last action or action state machine, the next action is identified in block 1130. The next action may be identified from associated data in, for example, the database, or as a result of the actions or action state machines being ordered when the service state machine is started or created, or when the action state machines are created. In block 1132, the next action is set as the current action, and in block 1116, the current action state for the new current action state machine is set to active, and the process or performance of the new current action is repeated.

When the service state machine or system determines that the most recently finished action is the last action, then the service itself is finished, and the state of the service state machine is set to a ready-to-deliver state, to an OTD state, to a done state, or to another state that is not active, but that indicates that the actions of the service are not being executed.

In some embodiments, once the service state machine is in a ready-to-deliver state or OTD state, the goods and services, or final deliverables, associated with service are ready for delivery, and the system may wait to receive a delivery verification in block 1136, and the service state machine may terminate or be set to a done state in block 1138.

An embodiment system includes a processor, and a non-transitory computer readable medium storing a computer program for execution by the processor for managing event scheduling. The computer program including instructions for providing a service state machine for a service selected by an organizer for an organizer event, setting, by the service state machine, a state of each action state machine of a plurality of action state machines associated with a plurality of actions associated with the service to an active state, the setting the state causing the action state machine to perform elements associated with a respective action associated with the respective action state machine while the state of the respective action machine is active, where the service state machine sets the state of each action state machine according to an order of the plurality of actions, where each action of the plurality of actions is identified by a provider prior to the service state machine being provided, where at least one action has an element that includes receiving an action performance indication from the organizer, and setting a state of the service state machine to a ready-to-deliver state after each action state machine of the plurality of action state machines completes performance of associated elements.

In some embodiments, the computer program further includes instructions for receiving, from a provider, data for creating the service, and receiving, from the provider, data indicating an association between the service and at least one action of the plurality of actions. In some embodiments, the computer program further includes instructions for receiving a service start authorization indicating that the service state machine is authorized to start, and setting a state of the service state machine to active in response to receiving the service start authorization. In some embodiments, the instructions for setting the state of each action state machine of a plurality of action state machines include instructions for identifying a current action from the plurality of actions, setting a state of a current action state machine associated with the current action to active, and performing elements associated with the current action while the state of the current action is active. In some embodiments, the instructions for performing the elements associated with the current action include instructions for receiving an action performance indication at the current action state machine, setting the state of the current action state machine to a ready-to-deliver state in response to the action performance indication, determining, according to the order of the plurality of actions, whether a next action exists in the plurality of actions, performing, in response to determining that the next action exists, determining the next action to be the current action, setting the state of a current action state machine associated with the current action to active, and performing elements associated with the current action while the state of the current action is active, and performing, in response to not determining that the next action exists, setting the state of the service state machine to a ready-to-deliver state. In some embodiments, at least one action of the plurality of actions has an element that includes providing, to a responsible party associated with the respective action, prompt data indicating to the responsible party to provide the action performance indication indicating that an action has been performed. In some embodiments, at least one action of the plurality of actions has an element that includes providing, to a responsible party associated with the respective action, according to a deadline associated with the respective at least one action, a reminder to the responsible party to provide data regarding the respective action.

An embodiment system includes a processor and a non-transitory computer readable medium storing a computer program for execution by the processor for managing event scheduling. The computer program including instructions for providing a service state machine for a service selected for an organizer event, identifying a plurality of actions associated with the service, providing at least one action state machine associated with the plurality of actions, and controlling, by the service state machine, running of the at least one action state machine to perform the plurality of actions in sequence.

In some embodiments, the computer program further includes instructions for receiving, from a provider, data for creating the service, and receiving, from the provider, data indicating an association between the service and at least one action of the plurality of actions. In some embodiments, the computer program further includes instructions for receiving, from an organizer, data indicating a selection of the service for the organizer event. In some embodiments, the computer program further includes instructions for receiving a service start authorization indicating that the service state machine is authorized to start, and setting a state of the service state machine to active in response to receiving the service start authorization. In some embodiments, the instructions for controlling the running of the at least one action state machine include instructions for identifying a current action from the plurality of actions, setting a state of a current action state machine associated with the current action to active, and performing elements associated with the current action while the state of the current action is active. In some embodiments, the instructions for performing the elements associated with the current action include instructions for receiving an action performance indication at the current action state machine, setting the state of the current action state machine to a ready-to-deliver state in response to the action performance indication, determine whether a next action exists in the plurality of actions, performing, in response to determining that the next action exists determining the next action to be the current action, setting the state of a current action state machine associated with the current action to active, and performing elements associated with the current action while the state of the current action is active, and performing, in response to not determining that the next action exists, setting the state of the service state machine to a ready-to-deliver state. In some embodiments, the instructions for performing the elements associated with the current action include instructions for providing, to a responsible party associated with the current action, prompt data indicating to the responsible party to provide data indicating that an action has been performed.

An embodiment method for managing event scheduling includes providing a service state machine for a service selected for an organizer event, identifying a plurality of actions associated with the service, providing at least one action state machine associated with the plurality of actions, and controlling, by the service state machine, running of the at least one action state machine to perform the plurality of actions in sequence.

In some embodiments, the method further includes receiving, from a provider, data for creating the service, and receiving, from the provider, data indicating an association between the service and at least one action of the plurality of actions. In some embodiments, the method further includes receiving a service start authorization indicating that the service state machine is authorized to start, and setting a state of the service state machine to active in response to receiving the service start authorization. In some embodiments, controlling the running of the at least one action state machine includes identifying a current action from the plurality of actions, setting a state of a current action state machine associated with the current action to active, and performing elements associated with the current action while the state of the current action is active. In some embodiments, performing the elements associated with the current action includes receiving an action performance indication at the current action state machine, setting the state of the current action state machine to a ready-to-deliver state in response to the action performance indication, determine whether a next action exists in the plurality of actions, performing, in response to determining that the next action exists, determining the next action to be the current action, setting the state of a current action state machine associated with the current action to active, and performing elements associated with the current action while the state of the current action is active, and performing, in response to not determining that the next action exists, setting the state of the service state machine to a ready-to-deliver state. In some embodiments, performing the elements associated with the current action includes providing, to a responsible party associated with the current action, prompt data indicating to the responsible party to provide data indicating that an action has been performed.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A system, comprising:
a processor; and
a non-transitory computer readable medium storing a computer program for execution by the processor for managing event scheduling, the computer program including instructions for:
providing a service state machine for a service selected by an organizer for an organizer event;
setting, by the service state machine, a state of each action state machine of a plurality of action state machines associated with a plurality of actions associated with the service to an active state, the setting the state causing the action state machine to perform elements associated with a respective action associated with the respective action state machine while the state of the respective action machine is active, wherein the service state machine sets the state of each action state machine according to an order of the plurality of actions, wherein each action of the plurality of actions is identified by a provider prior to the service state machine being provided, wherein at least one action has an element that comprises receiving an action performance indication from the organizer; and
setting a state of the service state machine to a ready-to-deliver state after each action state machine of the plurality of action state machines completes performance of associated elements.

2. The system of claim 1, wherein the computer program further includes instructions for:
receiving, from a provider, data for creating the service; and
receiving, from the provider, data indicating an association between the service and at least one action of the plurality of actions.

3. The system of claim 1, wherein the computer program further includes instructions for:
receiving a service start authorization indicating that the service state machine is authorized to start; and
setting a state of the service state machine to active in response to receiving the service start authorization.

4. The system of claim 3, wherein the instructions for setting the state of each action state machine of a plurality of action state machines include instructions for:
identifying a current action from the plurality of actions;
setting a state of a current action state machine associated with the current action to active; and
performing elements associated with the current action while the state of the current action is active.

5. The system of claim 4, wherein the instructions for performing the elements associated with the current action include instructions for:
receiving an action performance indication at the current action state machine;
setting the state of the current action state machine to a ready-to-deliver state in response to the action performance indication;
determining, according to the order of the plurality of actions, whether a next action exists in the plurality of actions;
performing, in response to determining that the next action exists:
determining the next action to be the current action;
setting the state of a current action state machine associated with the current action to active; and
performing elements associated with the current action while the state of the current action is active; and
performing, in response to not determining that the next action exists:
setting the state of the service state machine to a ready-to-deliver state.

6. The system of claim 5, wherein at least one action of the plurality of actions has an element that comprises:
providing, to a responsible party associated with the respective action, prompt data indicating to the responsible party to provide the action performance indication indicating that an action has been performed.

7. The system of claim 5, wherein at least one action of the plurality of actions has an element that comprises:
providing, to a responsible party associated with the respective action, according to a deadline associated with the respective at least one action, a reminder to the responsible party to provide data regarding the respective action.

8. A system, comprising:
a processor; and
a non-transitory computer readable medium storing a computer program for execution by the processor for managing event scheduling, the computer program including instructions for:
providing a service state machine for a service selected for an organizer event;
identifying a plurality of actions associated with the service;
providing at least one action state machine associated with the plurality of actions; and
controlling, by the service state machine, running of the at least one action state machine to perform the plurality of actions in sequence.

9. The system of claim 8, wherein the computer program further includes instructions for:
receiving, from a provider, data for creating the service; and
receiving, from the provider, data indicating an association between the service and at least one action of the plurality of actions.

10. The system of claim 9, wherein the computer program further includes instructions for:
receiving, from an organizer, data indicating a selection of the service for the organizer event.

11. The system of claim 8, wherein the computer program further includes instructions for:
receiving a service start authorization indicating that the service state machine is authorized to start; and
setting a state of the service state machine to active in response to receiving the service start authorization.

12. The system of claim 11, wherein the instructions for controlling the running of the at least one action state machine include instructions for:
identifying a current action from the plurality of actions;
setting a state of a current action state machine associated with the current action to active; and
performing elements associated with the current action while the state of the current action is active.

13. The system of claim 12, wherein the instructions for performing the elements associated with the current action include instructions for:
receiving an action performance indication at the current action state machine;
setting the state of the current action state machine to a ready-to-deliver state in response to the action performance indication;
determine whether a next action exists in the plurality of actions;
performing, in response to determining that the next action exists:
determining the next action to be the current action;
setting the state of a current action state machine associated with the current action to active; and
performing elements associated with the current action while the state of the current action is active; and
performing, in response to not determining that the next action exists:
setting the state of the service state machine to a ready-to-deliver state.

14. The system of claim 13, wherein the instructions for performing the elements associated with the current action include instructions for:
providing, to a responsible party associated with the current action, prompt data indicating to the responsible party to provide data indicating that an action has been performed.

15. A method for managing event scheduling, the method comprising:
providing a service state machine for a service selected for an organizer event;
identifying a plurality of actions associated with the service;
providing at least one action state machine associated with the plurality of actions; and
controlling, by the service state machine, running of the at least one action state machine to perform the plurality of actions in sequence.

16. The method of claim 15, further comprising:
receiving, from a provider, data for creating the service; and
receiving, from the provider, data indicating an association between the service and at least one action of the plurality of actions.

17. The method of claim 15, further comprising:
receiving a service start authorization indicating that the service state machine is authorized to start; and
setting a state of the service state machine to active in response to receiving the service start authorization.

18. The method of claim 17, wherein the controlling the running of the at least one action state machine comprises:
identifying a current action from the plurality of actions;
setting a state of a current action state machine associated with the current action to active; and
performing elements associated with the current action while the state of the current action is active.

19. The method of claim 18, wherein the performing the elements associated with the current action comprises:
receiving an action performance indication at the current action state machine;
setting the state of the current action state machine to a ready-to-deliver state in response to the action performance indication;
determine whether a next action exists in the plurality of actions;
performing, in response to determining that the next action exists:
determining the next action to be the current action;
setting the state of a current action state machine associated with the current action to active; and
performing elements associated with the current action while the state of the current action is active; and
performing, in response to not determining that the next action exists:
setting the state of the service state machine to a ready-to-deliver state.

20. The method of claim 19, wherein the performing the elements associated with the current action comprises:
providing, to a responsible party associated with the current action, prompt data indicating to the responsible party to provide data indicating that an action has been performed.
